(19) United States
(12) Patent Application Publication
(10) Pub. No.: US 2021/0142373 A1
(43) Pub. Date: May 13, 2021

(54) Non-Transitory Computer Readable Medium and Information Processing Method

(71) Applicant: NearMe, Inc., Tokyo (JP)

(72) Inventor: Koichiro Takahara, Tokyo (JP)

(21) Appl. No.: 17/043,185

(22) PCT Filed: Mar. 29, 2019
(86) PCT No.: PCT/JP2019/014354

§ 371 Date: Sep. 29, 2020

(30) Foreign Application Priority Data
Mar. 30, 2018 (JP) 2018-070218

(51) Int. Cl. G06Q 30/02; G06Q 50/30; G08G 1/00; G06Q 10/02

(52) U.S. Cl. CPC G06Q 30/0284; G06Q 50/30; G01C 21/3438; G06Q 10/02; G08G 1/202

(57) ABSTRACT

Provided is a non-transitory computer readable medium or the like for matching passengers having a merit in sharing a taxi. The non-transitory computer readable medium including program instructions which when executed by a processor causing a computer to execute a process comprising: acquiring, by the processor, a candidate sharing a taxi and a calculated cost in the case of sharing with the candidate; displaying, by the processor, the candidate and the calculated cost that are acquired; and accepting, by the processor, selection of whether or not to share with the displayed candidate.

### CROSS-REFERENCE TO RELATED APPLICATIONS

This application is the national phase under 35 U. S. C. § 371 of PCT International Application No. PCT/JP2019/014354 which has an International filing date of Mar. 29, 2019, which claims priority under 35 U.S.C. § 119 on Patent Application No. 2018-070218 filed in Japan on Mar. 30, 2018, and designated the United States of America.

### FIELD

The present invention relates to a non-transitory computer readable medium and an information processing method.

### BACKGROUND

A so-called shared-taxi for transporting a plurality of passengers who are not be personally acquainted with each other and share one vehicle transport has been used. A public transit system has been proposed in which a getting-in fare of each of the passengers using a shared-taxi is determined on the basis of a linear distance between a getting-in spot and a getting-out spot of the passenger.

### SUMMARY

However, in a system disclosed in Japanese Patent Application Laid-Open Publication No. 2002-74416, it is not possible to match a combination of passengers having a merit in sharing a taxi.

An object of one aspect is to match passengers having a merit in sharing a taxi.

A non-transitory computer readable medium including program instructions which when executed by a processor, causes a computer to execute processing of acquiring a candidate sharing a taxi and a calculated cost in the case of sharing with the candidate; displaying the candidate and the calculated cost that are acquired; and accepting selection of whether or not to share with the displayed candidate.

In one aspect, passengers having a merit in sharing a taxi can be matched.

The above and further objects and features will more fully be apparent from the following detailed description with accompanying drawings.

### BRIEF DESCRIPTION OF THE DRAWINGS

FIG. 1 is an explanatory diagram describing an outline of a taxi sharing system.

FIG. 2A is an explanatory diagram describing an outline of a fare of the taxi sharing system.

FIG. 2B is an explanatory diagram describing an outline of the fare of the taxi sharing system.

FIG. 3 is an explanatory diagram illustrating a configuration of the taxi sharing system.

FIG. 4 is an explanatory diagram describing a record layout of a user DB.

FIG. 5 is an explanatory diagram describing a record layout of a request DB.

FIG. 6 is an explanatory diagram describing a record layout of a matching DB.

FIG. 7 is an explanatory diagram illustrating a screen that is displayed by an information processing device.

FIG. 8 is an explanatory diagram illustrating a screen that is displayed by the information processing device.

FIG. 9 is an explanatory diagram illustrating a screen that is displayed by the information processing device.

FIG. 10 is an explanatory diagram illustrating a screen that is displayed by the information processing device.

FIG. 11 is an explanatory diagram illustrating a screen that is displayed by the information processing device.

FIG. 12 is an explanatory diagram illustrating a screen that is displayed by the information processing device.

FIG. 13 is a flowchart describing a processing flow of a program.

FIG. 14 is a flowchart describing a processing flow of a matching subroutine.

FIG. 15 is an explanatory diagram illustrating a notification screen that is displayed by the information processing device.

FIG. 16A is an explanatory diagram describing an outline of the fare of the taxi sharing system in the case of getting in a taxi in the middle.

FIG. 16B is an explanatory diagram describing an outline of the fare of the taxi sharing system in the case of getting in a taxi in the middle.

FIG. 17 is an explanatory diagram describing a record layout of a sharing condition DB.

FIG. 18 is a flowchart describing a processing flow of a matching subroutine of a second embodiment.

FIG. 19 is an explanatory diagram illustrating a screen that is displayed by a modification example of the information processing device that performs matching in the background.

FIG. 20A is an explanatory diagram describing an outline of a taxi sharing system of a third embodiment.

FIG. 20B is an explanatory diagram describing an outline of the taxi sharing system of the third embodiment.

FIG. 21 is an explanatory diagram illustrating a screen that is displayed by an information processing device of a fourth embodiment.

FIG. 22 is an explanatory diagram illustrating a screen that is displayed by the information processing device of the fourth embodiment.

FIG. 23 is an explanatory diagram illustrating a fare adjustment condition screen that is displayed on a display unit by an information processing device of a fifth embodiment.

FIG. 24 is a flowchart describing a processing flow of a program of the fifth embodiment.

FIG. 25 is a flowchart describing a processing flow of a correction fare adjustment subroutine.

FIG. 26 is an explanatory diagram describing an outline of a fare of a taxi sharing system of a sixth embodiment.

FIG. 27 is an explanatory diagram describing a record layout of a user DB of the sixth embodiment.

FIG. 28 is a flowchart describing a processing flow of a program of the sixth embodiment.

FIG. 29 is a flowchart describing a processing flow of the program of the sixth embodiment.

FIG. 30 is an explanatory diagram describing an outline of a fare of a taxi sharing system of a seventh embodiment.

FIG. 31 is a flowchart describing a processing flow of a program of the seventh embodiment.

FIG. 32 is an explanatory diagram describing a record layout of a condition DB.

FIG. 33 is an explanatory diagram illustrating a screen that is displayed by an information processing device of an eighth embodiment.

FIG. 34 is an explanatory diagram illustrating a screen that is displayed by the information processing device of the eighth embodiment.

FIG. 35 is a flowchart describing a processing flow of a matching subroutine of the eighth embodiment.

FIG. 36 is a functional block diagram of a taxi sharing system of a ninth embodiment.

FIG. 37 is an explanatory diagram illustrating a configuration of a taxi sharing system of a tenth embodiment.

### DETAILED DESCRIPTION

### First Embodiment

FIG. 1 is an explanatory diagram describing the outline of a taxi sharing system 10. In FIG. 1, many people are waiting in line on a taxi stand. A person illustrated by I in the drawing is registered as a nickname of “Ichiro”, and is a user I of the taxi sharing system 10. A person illustrated by K in the drawing is registered as a nickname of “Ko”, and is a user K of the taxi sharing system 10. The user I and the user K may not be personally acquainted with each other.

Each of the users is registered in advance in the taxi sharing system 10, and possesses an account. In account information of each of the users recorded in the taxi sharing system 10, a nickname and a credit possessed by the user are recorded. The details of the account information will be described below.

The user I inputs a getting-in spot and a getting-out spot into a first information processing device 201 (refer to FIG. 3). The first information processing device 201 transmits a user identifier (ID) that is uniquely applied to the user I, and a getting-in spot and a getting-out spot to a referral server 40. The user K inputs the getting-in spot and the getting-out spot to a second information processing device 202. The second information processing device 202 transmits a user ID that is uniquely applied to the user K, and a getting-in spot and a getting-out spot to the referral server 40. A user ID relevant to the other user (not illustrated), and a getting-in spot and a getting-out spot are also continually transmitted to the referral server 40. Note that, the first information processing device 201 and the second information processing device 202 are a general portable information processing device that is used by the user, such as a smart phone or a tablet.

The referral server 40 performs matching processing of the user. Specifically, the referral server 40 extracts a combination of two users who depart from the same getting-in spot. The referral server 40 calculates each fare in a case where each of the extracted users independently gets in a taxi in conjunction with a map server 49 and the case of sharing a taxi. The referral server 40 determines whether or not there is a merit in sharing a taxi.

Here, the fact that there is a merit, for example, indicates that a fare that is paid by each of two users sharing a taxi is less than a predicted cost in a case where each user independently gets in a taxi. The predicted cost is an example of a calculated cost that is calculated by the taxi sharing system 10 of this embodiment. In the following description, a case will be described in which the user I and the user K share a taxi, and the user I stops off, and thus, it is determined that both of the users have a merit in cost.

The referral server 40 transmits information relevant to a matching partner to the first information processing device 201 and the second information processing device 202. The first information processing device 201 and the second information processing device 202 acquire input of whether or not the user I and the user K agree with the matching, and transmit the input to the referral server 40.

A case where both of the user I and the user K agree with sharing a taxi will be described. The referral server 40 transmits information necessary for both of the users to specify each partner to the first information processing device 201 and the second information processing device 202. In a case where two users directly meet each other, and actually agree with sharing a taxi, the referral server 40 moves a credit corresponding to a sharing fare to the account of the user K from the account of the user I who is a stopping-off passenger.

The user I and the user K share the taxi as acquaintances who have known each other before getting in the taxi. The user I who is a stopping-off passenger gets out of the taxi without paying a taxi fare to a taxi driver. Note that, the user I who is a stopping-off passenger, as described above, has paid the credit corresponding to the sharing fare to the user K. The user K who gets out of the taxi later pays the taxi fare including an amount for taking a detour in order for the user I to stop off.

FIG. 2A and FIG. 2B are explanatory diagrams describing the outline of a fare of the taxi sharing system 10. In FIG. 2A and FIG. 2B, both of a fare and a required time are examples for description, and are not limited thereto.

FIG. 2A illustrates a fare and a required time in a case where the user I and the user K each independently taxi get in a taxi. The user I gets in the taxi from an A station to a B station. A taxi fare is 2570 yen, and a required time is 23 minutes. The user K gets in the taxi from the A station to a C station. A taxi fare is 2890 yen, and a required time is 25 minutes.

FIG. 2B illustrates a fare and a required time in a case where the user I and the user K share one taxi. First, the taxi travels from the A station to the B station, and the user I stops off at the B station. A required time to the B station is 23 minutes, as with a case where the user I independently gets in the taxi.

The referral server 40 subtracts a credit corresponding to 1606 yen obtained by adding a first charge of 321 yen that is a charge according to the user I to 1285 yen that is a first taxi fare corresponding to 50% of a fare of 2570 yen in a case where the user I independently gets in the taxi, from the account of the user I. That is, in the sharing, a first cost that the user I covers is 1606 yen, and is cheaper than 2570 yen that is a fare in a case where the user I independently gets in the taxi.

The charge includes various charges that are paid by the user to an operator of the taxi sharing system 10, such as a use charge of the taxi sharing system 10, a matching charge for matching the user I and the user K, and a payment charge. The user may pay a charge to the operator of the taxi sharing system 10 through a payment agency such as a credit-card company. In this case, the charge includes a charge that is paid by the user to the payment agency and a charge that is paid to the operator of the taxi sharing system 10.

The referral server 40 adds a credit corresponding to 964 yen obtained by subtracting a second charge of 321 yen that is a charge according to the user K from the first taxi fare of 1285 yen that is paid from the account of the user I, to the account of the user K. In addition, the second charge of 321 yen is subtracted from the credit of the user I.

The taxi travels from the B station to the C station. When the user K gets out of the taxi at the C station, the user K pays a second taxi fare of 3530 yen from the A station to the C station via the B station. A required time is 32 minutes. In the sharing, a second cost that the user K covers is a balance amount of 2566 yen between the second taxi fare of 3530 yen and 964 yen that is accepted from the user I through the taxi sharing system 10, and is cheaper than 2890 yen that is a fare in a case where the user K independently gets in the taxi.

As described above, it is possible to use a taxi with a low fare by the sharing, compared to a case where each of the user I and the user K independently gets in the taxi. For the taxi driver, the acquaintances get in the taxi together, and one gets out of the taxi in the middle, and thus, a procedure such as permission for the shared-taxi is not necessary.

The operator of the taxi sharing system 10, a total charge income of 642 yen is obtained from the user I and the user K of 321 yen each. Note that, in FIG. 2B, 25% of the first taxi fare that is paid by the user I is a charge that is paid by each of the users. Matching charges that are paid by two users may be different from each other. The charge may be a fixed charge such as 300 yen per one sharing.

The first taxi fare that is paid by the user I is not limited to 50% of the fare of 2570 yen in a case where the user I independently gets in the taxi. The first taxi fare can be set to an arbitrary amount in a range in which both of the user I and the user K have a merit. A ratio of the first taxi fare may be dynamically adjusted such that a maximum profit is obtained in the matching with the user.

Note that, in the following description, a user who is a stopping-off passenger, such as the user I, may be referred to a ride friend, and a user who is a final getting-out passenger who gets in the taxi to a final getting-out spot, such as the user K, may be referred to a ride leader.

FIG. 3 is an explanatory diagram illustrating the configuration of the taxi sharing system 10. The taxi sharing system 10, as described above, the referral server 40, the first information processing device 201, the second information processing device 202, and the map server 49, which are connected through a network.

The first information processing device 201 includes a first central processing unit (CPU) 211, a main storage device 221, an auxiliary storage device 231, a communication unit 241, a touch panel 251, global positioning system (GPS) 281, and a bus. The first CPU 211 is an arithmetic operation control device that executes the program of this embodiment. In the first CPU 211, one or a plurality of CPUs, a multi-core CPU, or the like is used. The first CPU 211 is connected to each hardware unit configuring the first information processing device 201 through the bus.

The main storage device 221 is a storage device such as a static random access memory (SRAM), a dynamic random access memory (DRAM), and a flash memory. In the main storage device 221, information that is necessary during processing performed by the first CPU 211 and a program that is executed by the first CPU 211 are temporarily stored.

The auxiliary storage device 231 is a storage device such as an SRAM, a flash memory, or a hard disk. In the auxiliary storage device 231, the program to be executed by the first CPU 211 and various data items that are necessary for executing the program are stored.

The communication unit 241 is an interface in which data communication between the first information processing device 201 and the network is performed. The touch panel 252 includes a display unit 261 such as a liquid crystal display panel, and an input unit 271 that is laminated on the display unit 261.

The GPS 281 performs positioning on the basis of a radio wave of a position information satellite, a radio wave of a base station, or the like, and outputs positioning information indicating the position of the first information processing device 201. Note that, in this embodiment, the GPS is described, but the position information satellite is not limited to a GPS satellite of the U.S. An arbitrary position information satellite such as Galileo of European Union (EU), a global navigation satellite system (GNSS) such as a global navigation satellite system (GLONASS) of Russia, and Michibiki that is a quasi-zenith satellite can be used. In addition, radio waves of such position information satellites can be used by being combined.

The second information processing device 202 includes a second CPU 212, a main storage device 222, an auxiliary storage device 232, a communication unit 242, a touch panel 252, a GPS 282, and a bus. The second CPU 212 is an arithmetic operation control device that executes the program of this embodiment. In the second CPU 212, one or a plurality of CPUs, a multi-core CPU, or the like is used. The second CPU 212 is connected to each hardware unit configuring the second information processing device 202 through the bus.

The main storage device 222 is a storage device such as an SRAM, a DRAM, and a flash memory. In the main storage device 222, information that is necessary during the processing performed by the second CPU 212 and a program that is executed by the second CPU 212 are temporarily stored.

The auxiliary storage device 232 is a storage device such as an SRAM, a flash memory, or a hard disk. In the auxiliary storage device 232, the program to be executed by the second CPU 212 and various data items that are necessary for executing the program are stored.

The communication unit 242 is an interface in which data communication between the second information processing device 202 and the network is performed. The touch panel 252 includes a display unit 262 such as a liquid crystal display panel, and an input unit 272 that is laminated on the display unit 262.

The GPS 282 performs positioning on the basis of a radio wave of a position information satellite, a radio wave of a base station, or the like, and outputs positioning information indicating the position of the second information processing device 202.

Note that, the first information processing device 201 and the second information processing device 202 are examples of a plurality of information processing devices 20 that are included in the taxi sharing system 10. In the following description, in the case of not distinguishing the information processing devices 20 from each other, the information processing devices 20 will be described as the information processing device 20. Similarly, each constituent of the information processing device 20 will be described as a CPU 21, a main storage device 22, an auxiliary storage device 23, a communication unit 24, a touch panel 25, a display unit 26, an input unit 27, and a GPS 28.

The referral server 40 includes a referral CPU 41, a main storage device 42, an auxiliary storage device 43, a communication unit 44, and a bus. The referral CPU 41 is an arithmetic operation control device that executes the program of this embodiment. In the referral CPU 41, one or a plurality of CPUs, a multi-core CPU, or the like is used. The referral CPU 41 is connected to each hardware unit configuring the referral server 40 through the bus.

The main storage device 42 is a storage device such as an SRAM, a DRAM, and a flash memory. In the main storage device 42, information that is necessary during processing that is performed by the referral CPU 41 and a program that is executed by the referral CPU 41 are temporarily stored.

The auxiliary storage device 43 is a storage device such as an SRAM, a flash memory, a hard disk, or a magnetic tape. In the auxiliary storage device 43, a user database (DB) 51, a request DB 52, a matching DB 53, the program to be executed by the referral CPU 41, and various data items that are necessary for executing the program are stored. Note that, the user DB 51, the request DB 52, and the matching DB 53 may be stored in an external high-capacity storage device or the like that is connected to the referral server 40.

The communication unit 44 is an interface in which communication between the referral server 40 and the network is performed. The referral server 40 may be a virtual machine that is operated on a large-scale calculator. The referral server 40 may be configured by combining a plurality of computers or a plurality of server machines.

FIG. 4 is an explanatory diagram illustrating a record layout of the user DB 51. The user DB 51 is a DB recording account information in which a user ID, a nickname, registered information, a possessed credit, and usage history are associated with evaluation.

The user DB 51 includes a user ID field, a nickname field, a registered information field, a possessed credit field, a usage history field, and an evaluation field. The registered information field includes a name field, an address field, a phone number field, and a gender field. The usage history field includes a total use frequency field and a total travel distance field. The evaluation field includes a good field and a bad field.

In the user ID field, the user ID is recorded. In the nickname field, the nickname of the user is recorded. In the name field, the name of the user is recorded. In the address field, the address of the user is recorded. In the phone number field, the phone number of the user is recorded. In the gender field, the gender of the user is recorded.

In the possessed credit field, a credit that is possessed by the user is recorded. In this embodiment, the unit of the credit is Japanese yen, but is not necessarily limited to Japanese yen, and may be a foreign currency, a point that is issued by the operator of the taxi sharing system 10, or the like. The user is capable of allocating the possessed credit to the payment with respect to the ride leader and the payment of the charge of the taxi sharing system 10.

The user is capable of performing the payment with respect to the ride leader and the payment of the charge of the taxi sharing system 10 by using the credit, and may perform the payment through a credit card or a payment agent. In addition, in a case where the possessed credit is less than the amount of payment, the user is not capable of performing the payment using the credit, and thus, performs the payment through the credit card or the payment agent.

The user is capable of performing by paying the credit recorded in the possessed credit field into a bank account or the like of the user. In this case, an amount obtained by subtracting a bank charge from the credit is paid into the bank account.

The user may be capable of using the credit recorded in the possessed credit field in the payment of the taxi fare. In such a case, pay processing is performed with respect to the account of a taxi company from the referral server 40 directly or through the other payment system.

In the total use frequency field, the number of times that the user uses the taxi sharing system 10 is recorded. In the total travel distance field, a distance that the user travels by using the taxi sharing system 10 is recorded. In the good field, the number of times that evaluation of “Good” is obtained from a sharing partner is recorded. In the bad field, the number of times that evaluation of “Bad” is obtained from the sharing partner is recorded. The user DB 51 has one record with respect to one user or a set of users using the taxi sharing system 10.

FIG. 5 is an explanatory diagram describing a record layout of the request DB 52. The request DB 52 is a DB in which the user ID, the nickname, the getting-in spot at which the user hopes to share the taxi and the getting-out spot, a request time, and the fare and the required time in a case where the user independently gets in the taxi are recorded by being associated with each other.

The request DB 52 includes a user ID field, a nickname field, a getting-in spot field, a getting-out spot field, a request time field, and an independently getting-in field. The independently getting-in field includes a fare field and a required time field.

In the user ID field, the user ID is recorded. In the nickname field, the nickname of the user is recorded. In the getting-in spot field, the getting-in spot of the user is recorded. In the getting-out spot field, the getting-out spot of the user is recorded. In the request time field, a time when the user transmits a sharing request to the taxi sharing system 10 is recorded.

In the fare field, a time when the user independently gets in the taxi from the getting-in spot to the getting-out spot is recorded. In the required time field, the required time of the taxi from the getting-in spot to the getting-out spot is recorded. The referral CPU 41 transmits the getting-in spot and the getting-out spot to the map server 49, acquires the taxi fare and the required time, and records the taxi fare and the required time in the request DB 52. The request DB 52 has one record with respect to one user hoping to share the taxi.

FIG. 6 is an explanatory diagram describing a record layout of the matching DB 53. The matching DB 53 is a DB in which a set of users having a merit in sharing a taxi, a riding route, the collection of the credit, and a matching situation are recorded by being associated with each other.

The matching DB 53 includes a ride leader field, a ride friend field, a route field, a credit field, and a situation field. The ride leader field includes a user ID field and a current spot field. The ride friend field includes a user ID field and a current spot field. The route field includes a getting-in spot field, a stopover spot field, and a getting-out spot field. The credit field includes a friend credit field and a leader credit field.

In the user ID field of the ride leader field, the user ID of the user who gets in the taxi to the getting-out spot is recorded. In the current spot field of the ride leader field, the current spot of the ride leader is recorded. The current spot is continually updated by transmitting information that is acquired by the built-in GPS 28 from the information processing device 20 that is used by the ride leader.

In the user ID field of the ride friend field, the user ID of the user who gets out of the taxi at the stopover spot is recorded. In the current spot field of the ride friend field, the current spot of the ride friend is recorded.

In the getting-in spot field, a place in which the user who shares the taxi gets in the taxi is recorded. In the stopover spot field, a place in which the ride friend gets out of the taxi is recorded. In the getting-out spot field, a place in which the ride leader gets out of the taxi is recorded. In the friend credit field, the credit that is paid by the ride friend is recorded. In the leader credit field, the credit that is accepted by the ride leader is recorded. In the situation field, a matching progress such as “Checking” and “Start” is recorded.

FIG. 7 to FIG. 12 are explanatory diagrams illustrating a screen that is displayed by the information processing device 20. In the following description, a screen example to be displayed on the first information processing device 201 that is used by the user I or the second information processing device 202 that is used by the user K, which has been described by using FIG. 1, FIG. 2A, and FIG. 2B, is used.

FIG. 7 illustrates an input screen that is displayed on the display unit 262 of the second information processing device 202 before the user K requests sharing matching. A getting-in spot section 61 and a getting-out spot section 62 are displayed in the upper portion of the screen. A map section 63 is displayed in an upper half range of the screen. A getting-in spot name section 611 is displayed below the map section 63. A matching request button 711 is displayed below the getting-in spot name section 611.

The getting-in spot section 61 and the getting-out spot section 62 accepts the input of the getting-in spot and the getting-out spot from the user. A map including the getting-in spot and the getting-out spot that are accepted from the user is displayed in the map section 63. On the map, a getting-in spot mark 641 indicating the getting-in spot, a getting-out spot mark 642 indicating the getting-out spot, and a route mark 646 indicating a passage route of the taxi are displayed. The user hoping to share the taxi inputs the getting-in spot and the getting-out spot, and then, selects the matching request button 711.

The CPU 21 transmits the user ID, the getting-in spot, the getting-out spot, and the like to the referral server 40. The referral CPU 41 prepares a new record in the request DB 52, and records the user ID, the getting-in spot, the getting-out spot, and the like, which are received.

Note that, the CPU 21 may set the current spot of the information processing device 20 that is acquired through the GPS 28 to an initial value of the getting-in spot section 61. The user activating the program of this embodiment on the taxi stand is capable of omitting an operation for inputting the getting-in spot section 61.

The CPU 21 may set the address of the user that is recorded in the user DB 51 to an initial value of the getting-out spot section 62. The user using the taxi in order to go home is capable of omitting an operation for inputting the getting-out spot section 62.

FIG. 8 is a referral screen that is displayed on the display unit 262 of the second information processing device 202 after a candidate of the sharing partner and information according to the user I are received from the referral CPU 41.

On the map displayed in the map section 63, the getting-in spot mark 641 indicating the getting-in spot, the getting-out spot mark 642 indicating the getting-out spot, the stopover spot mark 643 indicating the stopover spot at which the user stops off, and the route mark 646 indicating the passage route of the taxi are displayed.

In the vicinity of the getting-in spot mark 641, the current spot of the user K, that is, a second current spot mark 644 indicating the current spot of the second information processing device 202 is displayed by a small circle with a solid line. Similarly, the current spot of the user I, that is, a first current spot mark 645 indicating the current spot of the first information processing device 201 is displayed by a small circle with a broken line.

A candidate icon section 651, a total use frequency section 652, and a total travel distance section 653 are displayed on the lower end of the map section 63. The outer circumference of the candidate icon section 651 is displayed by a broken line as with the first current spot mark 645. Note that, the first current spot mark 645 and the outer circumference of the candidate icon section 651 may be illustrated by the same color.

In the candidate icon section 651, an icon indicating the gender of “Male” of the user I that is recorded in the user DB 51 is displayed. Note that, in the candidate icon section 651, an icon such as a face photo registered by each of the users may be displayed. In such a case, the user DB 51 includes a field for recording an icon of each of the users.

In the total use frequency section 652, a total use frequency of the user I that is recorded in the user DB 51 is displayed. In the total travel distance section 653, a total travel distance of the user I that is recorded in the user DB 51 is displayed. A nickname section 657 is displayed below the candidate icon section 651. In the nickname section 657, the nickname of the user I that is recorded in the user DB 51 is displayed. Note that, even though it is not displayed in FIG. 8, information of the gender of the user may be displayed in the vicinity of the nickname section 657.

A cost section 654 and a candidate spot name section 655 are displayed below the nickname section 657. In the cost section 654, the required time and the fare in a case where the user K independently gets in the taxi, and the required time and the fare in a case where the user K and the user I share the taxi are displayed. In the candidate spot name section 655, the current spot of the user I is displayed. In a case where a spot name displayed in the candidate spot name section 655 is separated from the current spot of the user K, this indicates that the user I joins together during the travel of the taxi.

The user K is capable of determining whether or not to agree with sharing the taxi with the user I by looking at the cost section 654 and the candidate spot name section 655. In the case of agreeing with sharing the taxi with the user I, the user K selects a candidate approval button 712. In the case of not agreeing with sharing the taxi with the user I and of hoping to be matched with another candidate, the user K selects an another candidate button 713. In the case of withdrawing the sharing request, the user K selects a cancel button 714.

Note that, in a case where none of the buttons are selected even after a predetermined time has elapsed, the second CPU 212 determines that the selection of the cancel button 714 is accepted.

Note that, in a case where the selection of the candidate icon section 651 or the nickname section 657 is accepted, self-introduction or the like of the candidate may be displayed. The user easily determines whether or not the candidate is a user with whom a taxi can be reliably shared, by checking the self-introduction.

The referral CPU 41 may extract candidates of a plurality of sharing partners, and may present the candidates to the user. For example, in a case where the user performs a manipulation such as a flick manipulation on the referral screen illustrated in FIG. 8, the candidate of the next sharing partner is displayed. The user is capable of performing comparison examination with respect to a plurality of candidates before pressing the candidate approval button 712 or the another candidate button 713.

The plurality of candidates may be displayed on one screen as a list. For example, the plurality of candidates may be capable of being sorted in an arbitrary condition such as a fare order, a required time order, and an evaluation order.

The referral CPU 41, for example, may display the plurality of candidates in the order from the user having high evaluation, such as a descending order of the evaluation of “Good” or a descending order of a value obtained by subtracting the evaluation of “Bad” from the evaluation of “Good”, on the basis of the evaluation field of the user DB 51. It is possible to attain the taxi sharing system 10 in which the matching of the user having high evaluation is preferentially established.

FIG. 9 illustrates a check screen that is displayed on the display unit 261 of the first information processing device 201 in the case of receiving a sharing agreement from the second information processing device 202 through the referral server 40. As with FIG. 8, a check window 66 indicating that the user K who is a matching partner agrees with sharing the taxi may be pop-up displayed on the screen displaying that the matching with the user K is performed.

In the check window 66, a button for accepting whether or not to agree with sharing the taxi is displayed. In a case where the user I selects a button of “Yes”, an agreement between the user K and the user I is established.

FIG. 10 illustrates an establishment screen that is displayed on the display unit 261 of the first information processing device 201 in a case where the agreement between the user K and the user I is established.

On the map displayed in the map section 63, the getting-in spot mark 641 indicating the getting-in spot, the getting-out spot mark 642 indicating the getting-out spot, the stopover spot mark 643 indicating the stopover spot at which the user stops off, the route mark 646 indicating the passage route of the taxi, the first current spot mark 645 indicating the current spot of the first information processing device 201, and the second current spot mark 644 indicating the current spot of the second information processing device 202 are displayed. As described by using FIG. 1, the user I and the user K are waiting in line on the same taxi stand, and thus, in FIG. 10, the getting-in spot mark 641, the first current spot mark 645, and the second current spot mark 644 approximately overlap each other.

A result section 658 indicating that the nickname of the sharing partner and the user I are ride friends is displayed on the lower side of the map section 63. A current spot enlargement button 715, a chat start button 716, and a start button 717 are displayed on the lower side of the result section 658.

In the case of accepting the selection of the current spot enlargement button 715, the first CPU 211 displays a map focusing around the first current spot mark 645, which is enlarged to a scale in which the second current spot mark 644 is displayed separately from the first current spot mark 645, on the map section 63. The user I is capable of checking the position of the user K who is a matching partner on the map.

Note that, in a case where the user who is a sharing partner stops the execution of the program of this embodiment in the information processing device 20, the first current spot mark 645 is not displayed. As described above, after the sharing is ended, it is possible to prevent privacy information such as the place of home, from being disclosed with respect to the sharing partner.

In the case of accepting the selection of the chat start button 716, the first information processing device 201, the second information processing device 202, and the referral server 40 start a chat between the user I and the user K in conjunction with the acceptance. FIG. 11 illustrates an example of a chat screen. A message of the user K is displayed as a speech balloon from the left end of the screen, and a message of the user I is displayed as a speech balloon from the right of the screen. The user K and the user I are capable of determining a joining place by knowing each position of the users by the chat. A system for performing a chat between users has been used from the related art, and thus, the details of processing will be omitted.

The chat end button 719 and the start button 717 are displayed on the lower side of the chat screen. In the case of accepting the selection of the chat end button 719, the first CPU 211 returns to the screen described by using FIG. 10.

Note that, a call start button may be displayed instead of the chat start button 716 or along with the chat start button 716. In the case of accepting the selection of the call start button, the first information processing device 201, the second information processing device 202, and the referral server 40 starts a voice call between the user I and the user K, in conjunction with the acceptance. A system for performing a voice call between users has been used from the related art, and thus, the details of processing will be omitted.

The description will be continued by using FIG. 10 and FIG. 11. The cancel button 714 is displayed in the lower end portion of the screen illustrated in FIG. 10 and FIG. 11. In the case of accepting the selection of the cancel button 714 by any user, the matching between the user I and the user K is cancelled.

In the case of accepting the selection of the start button 717 illustrated in FIG. 10 and FIG. 11, the CPU 21 displays a confirmation screen for confirming the start of the sharing the taxi. FIG. 12 illustrates a screen that is displayed on the display unit 261 of the first information processing device 201 in the case of accepting the selection of the start button 717 by the user I. The required time and the fare in a case where the user I independently gets in the taxi, the required time and the fare in a case where the user I shares the taxi and stops off, and the breakdown of the fare are displayed. The icon and the nickname of the user K who is a ride leader are displayed below the fare. An approval button 720 is displayed on the lower side of the screen.

Note that, in the case of accepting the selection of the start button 717 by the user K, similarly, a fare according to the user K is displayed on the display unit 262 of the second information processing device 202. In the case of accepting the selection of the approval button 720 by both of the users, as described by using FIG. 2B, the referral CPU 41 subtracts the credit corresponding to 1606 yen from the account of the user I who is a ride friend, and adds the credit corresponding to 964 yen to the account of the user K who is a ride leader.

In the check screen described by using FIG. 12, the user may accept a change of the fare that is paid to the sharing partner. For example, only a change for increasing the fare that is paid to the ride leader is accepted from the ride friend, and a change for decreasing the fare that is accepted from the ride friend is accepted from the ride leader, and thus, it is possible to confirm the fare without performing a recheck with respect to the partner.

The fare that is paid to the ride leader from the ride friend, that is, a fare for a sharing zone may be capable of being changed later from a predicted fare, on the basis of the agreement between the ride friend and the ride leader. For example, in a case where a taxi fare when the ride friend gets out of the taxi is different from the predicted cost, one of the ride leader and the ride friend performs application for changing the fare with respect to the information processing device 20, the information processing device 20 notifies the application to the other of the ride leader and the ride friend, and the approval of the other is transmitted to the information processing device 20, and thus, the information processing device 20 may determine that there is an agreement in the change of the fare, and may change the amount of the predicted cost.

In addition, the change may be performed as described above. That is, a taximeter when the ride friend gets out of the taxi is checked by both of the ride friend and the ride leader. Changing a getting-in fare of the ride friend is agreed on the basis of the checked fare. The ride friend and the ride leader transmit the agreed amount to the referral CPU 41 through each of the information processing devices 20. The referral CPU 41 moves the credit in a case where the amounts received from both of the ride friend and the ride leader are coincident with each other.

In a case where at least one of the fare of the ride leader calculated at the time of performing matching and the fare of the ride friend is different from the actual fare, the referral CPU 41 may change a covering amount of both of the ride friend and the ride leader. In this case, the referral CPU 41, for example, acquires the taxi fare that is paid when the ride leader gets out of the taxi, and moves the credit between the ride leader and the ride friend.

In a case where the fare is changed later, the charge may be changed in conjunction with the fare after being changed. In this case, it is desirable that the CPU 21 automatically calculates the charge, and displays the charge on the display unit 26. Even in a case where the fare is changed later, the charge may be the same as an amount set at the time of start sharing the taxi. In this case, the charge is confirmed at the time of starting sharing the taxi.

FIG. 13 is a flowchart describing a processing flow of the program. The program of this embodiment is individually activated in each of the information processing devices 20. The first CPU 211 acquires the condition of the getting-in spot and the getting-out spot through the input screen described by using FIG. 7 (step S501).

In the case of accepting the selection of the matching request button 711, the first CPU 211 transmits a referral request to the referral CPU 41 (step S502). The referral CPU 41 accepts the referral request by interruption processing. The referral CPU 41 acquires the fare and the required time in a case where the user independently gets in the taxi from the getting-in spot to the getting-out spot, from the map server 49. The referral CPU 41 adds a new record to the request DB 52, and records the contents of the referral request.

Similarly, the second CPU 212 acquires the condition of the getting-in spot and the getting-out spot (step S601). In the case of accepting the selection of the matching request button 711, the second CPU 212 transmits the referral request to the referral CPU 41 (step S602). The referral CPU 41 accepts the referral request by the interruption processing, and records the referral request in the request DB 52.

The referral CPU 41 activates a matching subroutine (step S701). The matching subroutine is a subroutine for extracting a combination of the users having a merit in sharing the taxi from the record that is recorded in the request DB 52. A processing flow of the matching subroutine will be described below.

In the following description, a case will be described in which in the matching subroutine, the user according to the first information processing device 201 is selected as the ride friend, and the user according to the second information processing device 202 is selected as the ride leader. The referral CPU 41 notifies a candidate user to the first CPU 211 and the second CPU 212 according to the extracted candidate (step S702). The first CPU 211 and the second CPU 212 display the referral screen described by using FIG. 8 (step S503 and step S603).

The first CPU 211 and the second CPU 212 respectively acquire responses of the users, and transmit the responses to the referral CPU 41 (step S504 and step S604). The referral CPU 41 receives the responses from the both of the first CPU 211 and the second CPU 212 (step S703). The referral CPU 41 determines whether or not both of the users agree with sharing the taxi, and the matching is established (step S704).

In a case where it is determined that the matching is not established (in step S704, NO), the referral CPU 41 records “Not Established” in the situation field of the corresponding record of the matching DB 53, and returns to step S701. In a case where it is determined that the matching is established (in step S704, YES), the referral CPU 41 notifies the first CPU 211 that it is the ride friend, and notifies the second CPU 212 that it is the ride leader (step S705).

The first CPU 211 displays the establishment screen described by using FIG. 10, and displays that the user I is the ride friend (step S505). Similarly, the second CPU 212 displays that the user K is the ride leader such as “Matched with Ichiro. You Are Ride Leader” in the result section 658 of the establishment screen described by using FIG. 10 (step S605).

The first CPU 211 and the second CPU 212 respectively transmit the acceptance of the selection of the start button 717 to the referral CPU 41 (step S506 and step S606). The referral CPU 41 accepts each selection of the start button 717 by both of the users (step S706). The referral CPU 41 transmits a check instruction to the first CPU 211 and the second CPU 212 (step S707). The first CPU 211 and the second CPU 212 display the confirmation screen described by using FIG. 12 (step S507 and step S607).

The first CPU 211 and the second CPU 212 respectively transmit the acceptance of the selection of the approval button 720 to the referral CPU 41 (step S608 and step S608). The first CPU 211 and the second CPU 212 end the processing.

The referral CPU 41 performs fare adjustment with respect to the credits of the accounts of both of the users after accepting the selection of the approval button 720 by both of the users (step 708). Specifically, the referral CPU 41 subtracts a credit corresponding to the total of the fare and a referral fee from the account of the ride friend. The referral CPU 41 adds a credit corresponding to a fare obtained by subtracting the referral fee from the fare that is paid by the ride friend to the account of the ride leader. The referral CPU 41 returns to step S701.

Note that, in a flowchart illustrated in FIG. 13, payment is performed at a time point when both of the ride leader and the ride friend agree with sharing the taxi, and the matching is established, but a payment timing is not limited thereto. For example, both of the charges are paid at a matching time point or a sharing confirmation time point, but the sharing fare that is paid to the ride leader by the ride friend may be paid later (for example, at a time point when the ride friend gets out of the taxi). In this case, the referral CPU 41 may suspend the execution of step S708, and may execute the fare adjustment with respect to the credit when the ride friend gets out of the taxi. In addition, the charge of the ride leader may be paid at the matching time point or the sharing confirmation time point, and the charge of the ride friend and the sharing fare may be collectively paid later.

FIG. 14 is a flowchart describing the processing flow of the matching subroutine. The matching subroutine is a subroutine for extracting a combination of the users having a merit in sharing the taxi from the record that is recorded in the request DB 52.

A case where the map server 49 has a function of outputting route information by accepting “Departure Spot”, “Stopover Spot”, and “Destination” will be described as an example.

The referral CPU 41 extracts two records in which the getting-in spots are the same or close to each other, from the request DB 52 (step S751). Here, the referral CPU 41, for example, preferentially extracts a record with the earliest time that is recorded in the request time field. The referral CPU 41 may randomly extract a record.

The referral CPU 41 determines that a user corresponding to a first record in two extracted records is the ride leader, and a user corresponding to a second record is the ride friend (step S752). The referral CPU 41 sets an arbitrary spot such as the current spot of the ride leader and the ride friend, a halfway spot of the ride leader and the ride friend, or the nearest taxi stand from the halfway spot as “Departure Spot” that is a spot at which the user gets in the taxi. The referral CPU 41 sets the getting-out spot of the ride friend to “Stopover Spot”. The referral CPU 41 sets the getting-out spot of the ride leader to “Destination”.

The referral CPU 41 transmits “Departure Spot”, “Stopover Spot”, and “Destination” to the map server 49 (step S753). The referral CPU 41 acquires the route information from the map server 49 (step S754). In the route information, a route on the map, a taxi fare and a required time from “Departure Spot” to “Stopover Spot”, and a taxi fare and a required time from “Departure Spot” to “Destination” are included.

The referral CPU 41 calculates a cost that is covered by each of the ride friend and the ride leader (step S75). The referral CPU 41 acquires a fare in a case where the ride leader recorded in the fare field of the request DB 52 independently gets in the taxi. The referral CPU 41 determines whether or not the cost covered by the ride leader, which is calculated in step S755, is cheaper than the fare in a case where the ride leader independently gets in the taxi (step S756).

In a case where it is determined that the cost is cheaper than the fare (in step S756, YES), the referral CPU 41 acquires a fare in a case where the ride friend recorded in the fare field of the request DB 52 independently gets in the taxi. The referral CPU 41 determines whether or not the cost covered by the ride friend, which is calculated in step S755, is cheaper than the fare in a case where the ride friend independently gets in the taxi (step S757). In a case where it is determined that the cost is cheaper than the fare, the referral CPU 41 ends the processing.

In a case where it is determined that the cost of the ride leader does not decrease (in step S756, NO), or in a case where the cost of the ride friend does not decrease (in step S757, NO), the referral CPU 41 determines whether or not the user corresponding to the second record is the ride leader (step S758).

In a case where it is determined that the user corresponding to the second record is not the ride leader (in step S758. NO), the referral CPU 41 determines that the user corresponding to the second record in two records extracted in step S751 is the ride leader, and the user corresponding to the first record is the ride friend (step S759). The referral CPU 41 returns to step S753.

In a case where it is determined that the user corresponding to the second record is the ride leader (in step S758, YES), the referral CPU 41 returns to step S751.

The referral CPU 41 performs a questionnaire with respect to the user by means such as an e-mail, after the sharing is ended, acquires evaluation relevant to the sharing partner, and records the evaluation in the evaluation field of the user DB 51. The referral CPU 41 may perform the questionnaire with respect to the user by displaying a questionnaire screen to the touch panel 251 and the touch panel 252, after the sharing is ended. The acquisition of evaluation according to a user questionnaire has been performed from the related art, and thus, the details thereof will be omitted.

The taxi sharing system 10 may have a function of performing a notification in a case where there is a problem in the sharing partner. FIG. 15 is an explanatory diagram illustrating a notification screen that is displayed by the information processing device 20. A window in which a plurality of notification buttons 67 are arranged is pop-up displayed on the screen described by using FIG. 10. The notification button 67 includes a payment problem button 671, a behavior problem button 672, and the other notification button 673.

A user who is determined to have a problem manipulates a menu button (not illustrated), and displays the notification button 67. The user is capable of inputting a report relevant to the problem by suitably manipulating the notification button 67. The CPU 21 acquires the report that is input from the user, and transmits the report to the referral CPU 41. The referral CPU 41 records the received report.

The operator of the taxi sharing system 10 is capable of performing a suitable response such as fact-check with respect to people involved and the deregistration of a malicious user by browsing the report. In addition, a reporting function itself is a deterrent force for the user, and is capable of preventing the sharing partner from having discomfort feeling.

According to this embodiment, it is possible to provide the taxi sharing system 10 that is capable of matching the passengers having a merit in sharing one taxi. The users sharing the taxi are capable of checking the partners each other through the chat or the voice call described by using FIG. 11, and of determining that the partner is a safe partner, and then, of sharing one taxi.

According to this embodiment, as illustrated in FIG. 1, a plurality of users share one taxi on the taxi stand with a huge line, and thus, it is possible to reduce an average waiting time of all of the passengers waiting in a line on the taxi stand. A travel distance for each taxi increases by the sharing, and thus, an operating efficiency of the taxi increases.

The matching with the sharing partner and the joining with the partner can be performed before getting in the taxi, and thus, it is possible to provide the taxi sharing system 10 without applying a load to the taxi company side and the driver.

In a taxi that one user gets in, the other user may get in the taxi in the middle. A user getting in a car in the middle is capable of getting in the taxi without walking to the taxi stand. FIG. 16A and FIG. 16B are explanatory diagrams describing the outline of the fare of the taxi sharing system 10 in the case of getting in a taxi in the middle. In FIG. 16A and FIG. 16B, the fare and the required time are examples for description, and are not limited thereto.

Note that, a matching timing at the time of getting in the car in the middle includes both of a case where the matching is completed before both of the users share the car, and then, one user gets in the car first, and the other user gets in the car in the middle and a case where the matching is established while one user gets in the car, and the other user shares the car in the middle.

FIG. 16A illustrates the fare and the required time in a case where each of the user I and the user K independently gets in the taxi. The user I gets in the taxi from a D company to the B station. A taxi fare is 2570 yen, and a required time is 23 minutes. The user K gets in the taxi from the A station to the C station. A taxi fare is 2890 yen, and a required time is 25 minutes.

FIG. 16B illustrates the fare and the required time in a case where the user I and the user K share one taxi. The taxi that the user K gets in travels from the A station to the D company. The user I gets in the taxi at the D company. The user I and the user K share the taxi from the D company to the B station. The user I stops off at the B station. A required time from the D company to the B station is 23 minutes, as with a case where the user I independently gets in the taxi.

The referral server 40 subtracts a credit corresponding to 1606 yen that is obtained by adding the first charge of 321 yen that is a charge according to the user I to 1285 yen that is a first taxi fare corresponding to a sharing zone, from the account of the user I. That is, in the sharing, the first cost that the user I covers is 1606 yen, and is cheaper than 2570 yen that is the fare in a case where the user I independently gets in the taxi.

The referral server 40 adds the first taxi fare of 1285 yen that is paid from the account of the user I to the account of the user K, and subtracts a second charge of 321 yen that is a charge according to the user K from the account of the user K. That is, the referral server 40 adds a credit corresponding to 964 yen obtained by subtracting the second charge of 321 yen from the first taxi fare of 1285 yen, to the account of the user K.

The taxi travels from the B station to the C station. The user K pays the second taxi fare 3530 yen from the A station to the C station via the B station at the time of getting out of the taxi at the C station. A required time is 32 minutes. In the sharing, a second cost that the user K covers is a balance amount of 2566 yen between the second taxi fare of 3530 yen and 964 yen that is accepted from the user I through the taxi sharing system 10, and is cheaper than 2890 yen that is a fare in a case where the user K independently gets in the taxi.

Note that, the user K who gets in the taxi first may stop off. The user I and the user K may get out of the taxi in the same place.

In a range of riding capacity of the taxi, three or more users may share one taxi. Each of the users may get in and get out of the taxi at different places. In this case, in the case of accepting additional users sharing the taxi after the sharing is started, an agreement in all of the users who get in the taxi is necessary.

Communication is performed with the nicknames without disclosing the real names of the users sharing the taxi, and thus, it is possible to secure the privacy of the users. In addition, the users do not exchange cash with each other, and thus, it is possible to prevent the occurrence of a money trouble.

The referral CPU 41 may preferentially match the user having high evaluation, on the basis of the evaluation of the user that is accumulated in the evaluation field. As described above, it is possible to increase the user by increasing the evaluation of the system itself.

The referral CPU 41 may set the referral fee of the user having high evaluation to be low, and may set the referral fee of the user having low evaluation to be high, on the basis of the evaluation of the user that is accumulated in the evaluation field. Motivation for giving favorable impression to the sharing partner is given to each of the users. As described above, it is possible to increase the user by increasing the evaluation of the system itself.

The referral CPU 41 may set the referral fee of the user sharing the taxi with the user having high evaluation to be low. Motivation for actively accepting the matching with the user having high evaluation is given.

The referral CPU 41 may decrease the taxi fare in a case where the user having high evaluation gets in the taxi. For example, in a case where the user having high evaluation shares the taxi, the referral CPU 41 issues a coupon for discounting the taxi fare. The user having high evaluation has a feeling of superiority and a feeling of satisfaction, and thus, motivation for repeatedly using the system is given.

The fare may be collected from the ride friend through a payment service of a third person, instead of subtracting the credit from the account of the ride friend. In such a case, the user DB 51 includes a field in which payment information such as the account information of each of the users is recorded. A service for instant payment through a network has been known, and thus, the details thereof will be omitted.

A merit in sharing the taxi is not limited to a decrease in the cost, compared to a case where the user independently gets in the taxi. The referral CPU 41, for example, may determine whether or not to perform matching, on the basis of a decrease in a waiting time of the taxi, a decrease in a riding route of the taxi, a decrease in a riding time of the taxi, or the like.

The taxi company may cooperate with the operator of the taxi sharing system 10 of this embodiment, and the fare that is paid by the user of the taxi sharing system 10 may be the cost that is calculated by the taxi sharing system 10. For example, the taxi sharing system 10 may set the predicted cost from the departure spot to the getting-out spot of the ride leader, which is calculated in advance, to a confirmed cost that is paid when the ride leader gets out of the taxi. In this case, the confirmed cost is an example of the calculated cost that is calculated by the taxi sharing system 10 of this embodiment.

In a case where the taxi driver arrives at the destination by a route shorter than a route calculated by the map server 49 by utilizing the experience and the knowledge of the taxi driver, the taxi driver is paid a confirmed fare higher than a meter fare. The ride leader is capable of arriving at the destination earlier than the route calculated by the map server 49.

Each of the ride friend and the ride leader may directly pay the taxi fare. For example, the ride friend directly pays a friend fare described as “Payment for Ko” in FIG. 12 to the taxi. The ride leader directly pays an amount obtained by subtracting the friend fare from the actual taxi fare at the time of getting out of the taxi to the taxi.

As described above, the taxi company may cooperate with the operator of the taxi sharing system 10 of this embodiment (the taxi company approves that the amount presented by the taxi sharing system 10 is paid as the taxi fare), both of the ride leader and the ride friend may pay each amount that is calculated by the taxi sharing system 10 and is covered by each of the leader and the ride friend, or the ride leader may pay the total taxi fare that is calculated by the taxi sharing system 10.

The ride leader and the ride friend are capable of using arbitrary payment means such as cash or a credit card, in the payment of the taxi fare. The ride leader and the ride friend may use different payment means.

The taxi sharing system 10 of this embodiment may be used for sharing an arbitrary vehicle such as a bus, a private car, a truck, a motorcycle, or a bicycle. In this case, for example, a vehicle operational cost such as gas money and an expressway toll is used instead of the taxi fare. The effort of the driver may be calculated by an arbitrary method and may be added to the cost. A maintenance cost of the vehicle may be calculated by an arbitrary method and may be added to the cost.

The referral CPU 41 may transmit region information relevant to the getting-out spot or the getting-in spot of each of the users to the information processing device 20. The region information, for example, is arbitrary information relevant to a region, such as coupons of nearby stores, sightseeing spot information, weather forecast, or traffic information.

For example, the referral CPU 41 transmits the latest region information relevant to the getting-out spot to the information processing device 20 immediately before the user gets out of the taxi. The user is capable of utilizing the received latest information after getting out of the taxi. The referral CPU 41 may transmit the region information immediately after the user gets in the taxi. The user is capable of planning the action after getting out of the taxi by browsing the information transmitted while getting in the taxi.

### Second Embodiment

This embodiment relates to the taxi sharing system 10 in which each of the users is capable of registering a condition for rejecting sharing a taxi. The description of the same parts as those of the first embodiment will be omitted.

FIG. 17 is an explanatory diagram describing a record layout of a sharing condition DB. The sharing condition DB includes a user ID field and a condition field. In the user ID field, the user ID is recorded. In the condition field, a condition for each of the users to reject sharing the taxi, that is, a condition for filtering the sharing partner is recorded. For example, as illustrated in the first record of FIG. 17, a specific user ID is recorded in the condition field, and thus, it is possible to avoid matching with the user. The user is capable of setting a disapproval condition, on the basis of a gender, evaluation from the other user, a use result of the taxi sharing system 10, and the like.

FIG. 18 is a flowchart describing a processing flow of a matching subroutine of a second embodiment. The subroutine illustrated in FIG. 18 is a subroutine that is used instead of the subroutine described by using FIG. 14.

The referral CPU 41 extracts two records in which the getting-in spots are the same or close to each other, from the request DB 52 (step S751). The referral CPU 41 searches the sharing condition DB by using the user ID recorded in the user ID field of the record that is extracted in step S751, as a key, and determines the presence or absence of a record to be extracted (step S721).

In a case where it is determined that a record is extracted with respect to one user ID (in step S721, YES), the referral CPU 41 determines whether or not a user according to the other user ID corresponds to the condition recorded in the condition field (step S722).

In a case where it is determined that the user corresponds to the condition (in step S722, YES), the referral CPU 41 returns to step S751.

In a case where it is determined that the record is not extracted from the sharing condition DB (in step S721, NO), or in a case where it is determined that the user does not correspond to the condition recorded in the condition field (in step S722, NO), the referral CPU 41 determines that a user corresponding to a first record in two extracted records is the ride leader, and a user corresponding to a second record is the ride friend (step S752). The subsequent processing is the same as that of the subroutine described by using FIG. 14, and thus, the description thereof will be omitted.

According to this embodiment, each of the users is capable of setting a partner with whom the matching is rejected. Accordingly, it is possible to provide the taxi sharing system 10 that can be reliably used by the user.

The user may be capable of setting the necessity of the use of the disapproval condition each time when the matching is requested. The user is capable of using the disapproval condition on a taxi stand on which many people are waiting in a line and the matching is likely to be established, and of changing a condition in accordance with a situation such as not using the disapproval condition in a place in which the matching is less likely to be established.

The user may be capable of setting the disapproval condition each time when the matching is requested. The user is capable of suitably changing the disapproval condition, in accordance with the situation of that day.

In the sharing condition DB, a sharing hoping condition may be recorded instead of a sharing disapproval condition or in addition to the sharing disapproval condition. For example, it is possible to preferentially match partners of which the preferences are coincident with each other, on the basis of user attribute such as an age, a gender, an occupation, a hobby, or a favorite place. In such a case, the user DB 51 includes a field for recording the user attribute of the user.

In the sharing condition DB and the user DB 51, the user attribute such as calendar information, flight information, accommodation information, work information, or school information may be recorded. For example, it is possible to preferentially match users participating in the same event, on the basis of the calendar information. It is possible to preferentially match users registered in the same flight, on the basis of the flight information.

The referral CPU 41 may temporarily store a combination of users matched in a case where it is determined to be effective in step S756 in the main storage device 42 or the auxiliary storage device 43, may extract a combination in which one user is changed in step S751. The referral CPU 41 extracts a plurality of sharing partners with respect to one user, and then, for example, evaluates each of the sharing partners, on the basis of a distance between the users, a favorite place registered in advance, riding history in the past, or the user attribute. The referral CPU 41 matches a combination of users having high evaluation.

For example, users having the same hobby are matched, and thus, a matching system in which the users have a good conversation while sharing the taxi, and a new friendship can be established can be provided.

The favorite place described above may be automatically recorded in the sharing condition DB, on the basis of the riding history of the user in the past.

In the user DB 51, an allowable condition of the user may be recorded. For example, a condition such as covering a charge for the partner or matching a place or a time for getting in the taxi to the intention of the sharing partner may be recorded in a field that is added to the user DB 51.

The referral CPU 41 extracts the sharing partner in a condition in which the sharing partner accepts the allowable condition. The matching with respect to the user setting the allowable condition is easily established. For example, in a case where the taxi stand is crowded due to stormy weather, the user sets the allowable condition, and thus, it is possible to expect that the matching can be established quickly, and the user is capable of getting in the taxi.

The program of this embodiment may be operated in the background without selecting the matching request button 711 described by using FIG. 7. For example, the referral CPU 41 or the CPU 21 may perform the matching by determining the necessity of a taxi with an artificial intelligence (AI), on the basis of the riding history of the user in the past, the attribute, the current spot, the current time, the day, the weather, event information, and the like, and may notify the matching to the user through the display unit 26.

For example, a user who is drinking at a bar and may miss the last train checks a matching notification and gets in the taxi, and thus, is capable of arriving at the station in time for the last train. In addition, a user who is working overtime by missing the last train checks the matching notification, and thus, is capable of finishing the work.

The CPU 21 may perform the matching, on the basis of information of a ticket or the like that is purchased by the user with the information processing device 20. For example, matching with respect to a taxi heading to home is notified to a user arriving at the airport on the airplane of which the ticket is purchased by the user. Matching with respect to a taxi heading to a stadium is notified to a user going to a football match of which the ticket is purchased by the user before and after arriving at the nearest station of the stadium.

The CPU 21 may perform the matching, on the basis of data of scheduling software that is used by the user, or the like. For example, matching information of a taxi heading to the boarding station from the current spot is notified to a user planning to take a bullet train.

The CPU 21 may perform the matching, on the basis of the behavior history of the user in the past, the current position, and the like. For example, matching with respect to a taxi heading to a stadium is notified to a user frequently going to football match before and after arriving at the nearest station of the stadium on the date of the match.

By accumulating and learning the response of the user with respect to the matching, it is possible to attain the taxi sharing system 10 including an AI that accurately predicts the needs of the user and automatically starts the matching.

A user who accepts the selection of the matching request button 711 but is not capable of being matched within a predetermined time may be added to the candidate of the matching partner. In this case, the CPU 21 may accept the input of a waiting time for waiting the matching from the user. It is possible to provide the taxi sharing system 10 that responds to the needs of user who wants to take a taxi cheaply even in a case where the waiting time increases.

FIG. 19 is an explanatory diagram illustrating a screen that is displayed by a modification example of an information processing device 20 that performs the matching in the background. The screen illustrated in FIG. 19 illustrates an input screen that is displayed on the display unit 262 of the second information processing device 202 instead of the screen described by using FIG. 7.

A reason section 615 is displayed instead of the getting-in spot name section 611. The user arrives at an H airport by “J Airline 012 Flight” displayed in the reason section 615, and hopes to share a taxi to the C station.

The referral CPU 41 preferentially matches a user who arrives at the H airport by the same airplane. It is possible to provide the taxi sharing system 10 in which it is possible to share a taxi without a delay even in a case where an arrival time of the airplane is delayed.

The referral CPU 41 is capable of detecting the delay or the like of the flight that the user is boarding, with reference to flight information that is provided from the airport. In a case where an arrival time of one user is delayed, the referral CPU 41 may present a new sharing partner to the user who arrives as previously scheduled.

For example, in the reason section, a sport match schedule or the like may be input. It is possible to provide the taxi sharing system 10 in which it is possible to share a taxi without a delay even in a case where the matching is performed with respect to a user who is watching the same match or even in a case where an end time of the match that is being watched is later or earlier than the scheduled time.

### Third Embodiment

This embodiment relates to the taxi sharing system 10 that displays the sharing partner by augmented reality (AR). The description of the same parts as those of the first embodiment will be omitted.

FIG. 20A and FIG. 20B are explanatory diagrams describing the outline of the taxi sharing system 10 of a third embodiment. A waiting line on a taxi stand illustrated in FIG. 20A is photographed by a camera provided in the information processing device 20, and is displayed on the display unit 26. A star marker 73 is displayed on the user I on an image, on the basis of the coordinate of the current spot of the user I that is acquired from the referral CPU 41, and information of the GPS 28, a tilt sensor, or the like, which is embedded in the information processing device 20. A method for displaying an image photographed in real time and the marker 73 to be superimposed has been known, and thus, the description thereof will be omitted.

According to this embodiment, the user is capable of easily finding the matched partner and of joining together. In addition, it is possible to prevent the trouble of accidentally talking to a person who is different from the matching partner.

### Fourth Embodiment

This embodiment relates to the taxi sharing system 10 that calls a taxi in the case of getting in the taxi at a place other than a taxi stand. The description of the same parts as those of the first embodiment will be omitted.

FIG. 21 and FIG. 22 are explanatory diagrams illustrating a screen that is displayed by the information processing device 20 of a fourth embodiment. FIG. 21 illustrates a screen that is displayed on the display unit 261 of the first information processing device 201, instead of FIG. 10. A taxi call button 718 is displayed below the start button 717.

FIG. 22 illustrates a screen that is displayed on the display unit 26 in a case where the taxi call button 718 is selected. A plurality of attribute buttons 721 for selecting the attribute of a taxi that the user wants to get in (may include the attribute of the taxi driver), such as “Non-Smoking Taxi”, “Smoking Taxi”, “Female Driver”, “Male Driver”, “Wheelchair Available” “Available in English”, and “Available in Chinese”, are arranged. The user selects a transmission button 723 after selecting the attribute button 721 corresponding to the attribute of a desired taxi.

Note that, the attribute illustrated in FIG. 22 is an example. In addition to the illustrated items, for example, the age of the driver, whether or not the taxi is an owner-driven taxi, the name of the taxi company, the hobby of the driver, the presence or absence of internal odor, the designation of a desired seat, the presence or absence of a wireless local area network (LAN) service, the presence or absence a snack providing service, and the like may be capable of being selected.

The taxi sharing system 10 may collect the evaluation with respect to the driver from the user. A system for collecting evaluation from a user has been used from the related art, and thus, the description thereof will be omitted. In the case of collecting the evaluation, the level of an evaluation point from the user who got in the taxi in the past may be capable of being selected.

The taxi sharing system 10 may collect the evaluation with respect to the user from the driver. The evaluation from the driver, for example, is recorded in the evaluation field of the user DB 51. The evaluation from the other user and the evaluation from the driver may be recorded by being combined, or may be recorded separately.

The first CPU 211, for example, transmits the getting-in position, the name of the user I, and the attribute selected by the user to a dispatch server provided in the taxi company, and requests dispatch. The dispatch server or a dispatch operator of the taxi company instructs a taxi matched with the designated attribute to head to the getting-in position by using a vehicle wireless system or the like.

In addition, in a case where there is a taxi matched with the attribute, the dispatch server may perform as follows without immediately instructing the taxi to head to the getting-in position. That is, the dispatch server may transmit the information of the taxi matched with the attribute to the user I, the user I may transmit a dispatch request of the selected taxi to the dispatch server, on the basis of the information of the taxi, and the dispatch server may transmit an instruction for heading to the getting-in position to the taxi (in a case where the dispatch server transmits a plurality of information items of the taxi matched with the attribute to the user I, the user I may transmit the dispatch request of the taxi selected from the plurality of taxies to the dispatch server).

Here, the information of the taxi matched with the attribute may include the attribute of the taxi. In addition, a map may be displayed on the screen of the first information processing device 201 of the user I, information relevant to the position of the taxi matched with the attribute may be displayed on the map, and the information of the taxi selected by the user I (including information other than the position) may be further displayed.

Whether or not to be matched with the designated attribute can be determined on the basis of a database that is recorded in advance in the dispatch server. In a case where the social network system (SNS) account of the driver is registered in the database, the attribute may be determined on the basis of the matter registered in the SNS profile.

In a case where the first information processing device 201 has a calling function, the first CPU 211 may call the taxi company, may transmit a vehicle position, the name of the user I, and the attribute selected by the user by voice synthesis, and may request the dispatch.

According to this embodiment, it is possible to provide the taxi sharing system 10 in which it is possible to easily share a taxi even in a place other than a taxi stand.

According to this embodiment, it is possible to provide the taxi sharing system 10 in which it is possible to share a taxi by calling the taxi matched with the preference.

### Fifth Embodiment

This embodiment relates to the taxi sharing system 10 that is capable of correcting fare allocation after the sharing is started. The description of the same parts as those of the first embodiment will be omitted.

FIG. 23 is an explanatory diagram illustrating a fare adjustment condition screen that is displayed on the display unit 26 by the information processing device 20 of a fifth embodiment. The screen illustrated in FIG. 23 is a screen that is displayed in a case where a user manipulates a menu button (not illustrated) or the like after the sharing is started, and instructs the correction of the fare allocation.

A predicted cost in a case where the ride friend independently gets in a taxi, a covering amount in the sharing, a charge, and an amount paid by the ride friend are displayed on the upper side of FIG. 23. A predicted cost in a case where the ride leader independently gets in a taxi, a covering amount in the sharing, a charge, a received amount, a predicted cost at the time of getting out of the taxi, a predicted covering amount of the ride leader are displayed on the lower side of FIG. 23.

A correction pause button 724 and a correction approval button 725 are displayed on the bottom of FIG. 23. In FIG. 23, the correction approval button 725 is not capable of being selected.

The user is capable of changing the covering amount in the sharing of the ride friend, illustrated by an underline, and the predicted cost in a case where the ride leader gets out of the taxi, by manipulating the touch panel 251. In a case where the covering amount in the sharing of the ride friend is changed, the amount of payment in the item of the ride friend, illustrated in an oblique type, the covering amount in the sharing in the item of the ride leader, the received amount, and the predicted covering amount are automatically calculated again and are displayed. In a case where the fare when the ride leader gets out of the taxi is changed, the predicted covering amount of the ride leader is automatically calculated again and is displayed.

In a case where any changeable item is changed, the correction approval button 725 can be in a selectable state. In a case where one user selects the correction approval button 725, corrected information is displayed on the display unit 26 of the other user. In a case where the other user also selects the correction approval button 725, a credit corresponding to a balance amount with respect to the fare-adjusted amount is moved between the account of the ride leader and the account of the ride friend. As described above, allocation agreed before getting in the taxi can be changed after the sharing is started.

FIG. 24 is a flowchart describing a processing flow of the program of the fifth embodiment. The processing up to step S506 and step S606 is the same as that of the flowchart of the first embodiment described by using FIG. 13, and thus, the description thereof will be omitted.

The referral CPU 41 performs fare adjustment with respect to the credit of the account of both of the users after accepting the selection of the start button 717 by both of the users (step S731). That is, in this embodiment, the fare adjustment of the credit is performed after accepting the selection of the start button 717 on the screen described by using FIG. 10 and FIG. 11, without displaying the screen described by using FIG. 12.

The first CPU 211 determines whether or not to accept the selection of a button (not illustrated) for instructing the correction of the credit (step S521). In a case where it is determined that the selection is accepted (in step S521, YES), the first CPU 211 activates a correction calculation subroutine (step S522). The correction calculation subroutine is a subroutine for correcting the covering amount of the ride leader and the ride friend. A processing flow of the correction calculation subroutine will be described below.

Even in a case where the selection of the button for instructing the correction is not accepted when a predetermined time, for example, a time several times the predicted time until the ride leader arrives at the getting-out spot has elapsed (in step S521, NO), the first CPU 211 ends the processing.

The second CPU 212 determines whether or not to accept the selection of the button (not illustrated) for instructing the correction of the credit (step S621). In a case where it is determined that the selection is accepted (in step S621, YES), the first CPU 211 activates a correction calculation subroutine (step S622). The correction calculation subroutine is the same subroutine as the subroutine activated in step S522.

In a case where the selection of the button for instructing the correction is not accepted when a predetermined time, for example, a time several times the predicted time until the ride leader arrives at the getting-out spot has elapsed (in step S621, NO), the second CPU 212 ends the processing.

FIG. 25 is a flowchart describing a processing flow of a correction fare adjustment subroutine. The correction calculation subroutine is a subroutine for correcting the covering amount of the ride leader and the ride friend. In FIG. 25, a case where the first CPU 211 activates the correction calculation subroutine is described as an example.

The first CPU 211 displays a fare adjustment condition screen described by using FIG. 23, on the display unit 261 (step S531). The first CPU 211 accepts a change in a changeable item illustrated by an underline in FIG. 23. The first CPU 211 acquires the selection of the correction approval button 725 (step S532). The first CPU 211 transmits the contents of the correction to the referral CPU 41 (step S533). Note that, in a case where the selection of the correction pause button 724 is acquired before the correction approval button 725, the first CPU 211 ends the processing.

The referral CPU 41 receives the contents of the correction (step S741). The referral CPU 41 transmits the contents of the correction to the second CPU 212 (step S742). The second CPU 212 receives the contents of the correction (step S631). The second CPU 212 displays the same screen as the screen described by FIG. 23, on the display unit 262. Here, the correction of the amount is not accepted on the screen that is displayed on the display unit 262.

The second CPU 212 accepts the selection of the correction pause button 724 or the correction approval button 725 (step S632). The second CPU 212 transmits the accepted selection to the referral CPU 41 (step S633). The referral CPU 41 receives the transmitted selection (step S743).

The referral CPU 41 determines whether or not to accept the approval of the correction (step S744). In a case where it is determined that the approval is accepted (in step S744, YES), the referral CPU 41 performs fare adjustment with respect to the credit of the account of both of the users (step S745). That is, a balance amount between a credit subjected to the fare adjustment before getting in the taxi and a credit accepted on the screen of FIG. 23 is moved between the account of the ride leader and the account of the ride friend. The referral CPU 41 corrects the credit field of the corresponding record of the matching DB 53.

The referral CPU 41 notifies the end of the processing to the first CPU 211 after step S745 is ended or in a case where it is determined that the approval of the correction is not accepted (in step S744, NO) (step S746). The first CPU 211 displays whether or not the contents at the time when the processing is ended, that is, whether or not the correction transmitted in step S533 is approved (step S534).

According to this embodiment, it is possible to provide the taxi sharing system 10 that is capable of correcting the covering amount agreed by both of the ride leader and the ride friend in a case where a disbalance occurs in the covering amount between the ride leader and the ride friend, in accordance with a change in a road situation.

### Sixth Embodiment

This embodiment relates to the taxi sharing system 10 in which each of the users pays a fare to a taxi company. The description of the same parts as those of the first embodiment will be omitted.

FIG. 26 is an explanatory diagram describing the outline of the fare of the taxi sharing system 10 of a sixth embodiment. As with a case described by using FIG. 2A, a taxi fare in a case where the user I independently gets in the taxi from the A station to the B station is 2570 yen, and a taxi fare in a case where the user K independently gets in the taxi from the A station to the C station is 2890 yen.

As with a case described by using FIG. 2B, the user I and the user K share one taxi from the A station. The user I stops off at the B station, and then, the user K independently gets in the taxi to the C station. The second taxi fare from the A station to the C station via the B station is 3530 yen.

1285 yen that is the first taxi fare corresponding to 50% of the fare of 2570 yen in a case where the user I independently gets in the taxi is paid to the taxi company, and the first charge of 321 yen is paid to the operator of the referral server 40. That is, in the sharing, the first cost that the user I covers is 1606 yen, as with the second embodiment.

The user K pays 2245 yen obtained by subtracting the first taxi fare paid by the user I from the second taxi fare from the A station to the C station to the taxi company, and the second charge of 321 yen to the operator of the referral server 40. That is, in the sharing, the first cost that the user I covers is 2566 yen, as with the second embodiment.

The user is capable of using arbitrary means such as a payment system using a smart phone, a credit card, a bank transfer, or cash in any payment. Hereinafter, the case of using a small amount payment system will be described as an example.

Here, the outline of the small amount payment system will be described. The small amount payment system is a system in which money exchange can be performed with a small charge, compared to credit card payment, bank transfer, and the like. For example, various services such as a service for sending money to a remittance destination from money that is charged in advance by the user, and a service for withdrawing money from a credit card or a bank account that is registered in advance by the user and for sending the money to the remittance destination are provided.

The user designates the account of the remittance destination and the amount of remittance by using an application of the small amount payment service, which is installed in a smart phone or in a state of logging in a WEB site of the small amount payment service, and thus, is capable of performing the remittance.

In this embodiment, as described below, the account of the remittance destination and the amount of remittance are notified to the smart phone of the user. The application of the small amount payment service, which is installed in the smart phone, is manipulated by the user, and thus, the remittance with respect to the account of the remittance destination is performed.

FIG. 27 is an explanatory diagram describing a record layout of the user DB 51 of the sixth embodiment. The user DB 51 of this embodiment is a DB recording the account information in which the user ID, the nickname, the registered information, the payment information, and the usage history are associated with the evaluation.

The user DB 51 includes the user ID field, the nickname field, the registered information field, a payment information field, the usage history field, and the evaluation field. The user DB 51 is the same as the user DB 51 of the first embodiment described by using FIG. 4, except for the payment information field, and thus, the description thereof will be omitted.

In the payment information field, the name of the payment system that is registered in advance by the user, the account information, and the like are recorded. The information recorded in the payment information field is authenticated at the time of being registered, and is checked that the information can be used in payment processing.

FIG. 28 and FIG. 29 are flowcharts describing a processing flow of the program of the sixth embodiment. The processing up to step S507, step S707, and step S607 is the same as that of the flowchart of the first embodiment described by using FIG. 13, and thus, the description thereof will be omitted.

Both of the users who agree with sharing a taxi select the approval button 720 of the screen described by using FIG. 12 at the time of finding a taxi to take and starting the sharing.

The first CPU 211 performs processing of remitting the first charge to the operator of the taxi sharing system 10 in the case of accepting the selection of the approval button 720 (step S561). The description of the processing performed between the first CPU 211 and the payment system will be omitted.

The first CPU 211 acquires a taxi ID that is uniquely applied to the taxi that the user gets in (step S562). Note that, in the taxi ID, information indicating the taxi company is included. The taxi ID, for example, is posted in the taxi as a two-dimensional bar code. The user allows the first CPU 211 to read the taxi ID by using a bar code leader function provided in the first information processing device 201.

The taxi ID may be associated with the identification plate of the taxi. The user allows the first CPU 211 to read the taxi ID or manually inputs the taxi ID by using a camera function provided in the first information processing device 201 before getting in the taxi. The first CPU 211 transmits the taxi ID to the referral server 40 (step S563).

In a case where the selection of the approval button 720 is accepted, the second CPU 212 performs processing of remitting the second charge to the operator of the taxi sharing system 10 (step S661). The second CPU 212 acquires the taxi ID that is uniquely applied to the taxi that the user gets in (step S662). The second CPU 212 transmits the taxi ID to the referral server 40 (step S663).

The referral CPU 41 temporarily records each of the user ID and the taxi ID in the auxiliary storage device 43 in association with each other (step S762).

The taxi arrives at the getting-out spot of the user I with the first information processing device 201. The first CPU 211 transmits the friend fare from the departure spot to the getting-out spot of the user I who is a ride friend to the referral server 40 (step S564).

The friend fare, for example, is manually input into the first information processing device 201 by the user I looking at the taximeter. The first CPU 201 may transmit a photo of the taximeter, which is photographed by the user I with the camera function provided in the first information processing device 201, to the referral server 40. The first CPU 211 may acquire the friend fare from the taximeter through near field communication (NFC), a wireless LAN, or the like.

The referral CPU 41 temporarily records the user ID of the user I, the taxi ID, and the friend fare in the auxiliary storage device 43 in association with each other (step S763).

The taxi arrives at the getting-out spot of the user K with the second information processing device 202. The second CPU 212 transmits the second taxi fare from the departure spot to the getting-out spot of the user K who is a ride leader to the referral server 40 (step S664). A method for the second CPU 212 to acquire the second taxi fare is the same as that of the friend fare described above, and thus, the description thereof will be omitted.

The referral CPU 41 temporarily records the user ID of the user K, the taxi ID, and the second taxi fare in the auxiliary storage device 43 in association with each other (step S764). The referral CPU 41 calculates the taxi fare to be respectively allocated to the user I and the user K (step S765).

The allocation may be performed by a method in which the ride friend covers half of the friend fare, and the ride leader covers the remaining fare, as with the first embodiment, or may be performed by other arbitrary methods. For example, an allocation ratio or an allocation amount may be set by the user I and the user K while getting in the taxi, and may be transmitted to the referral server 40.

The referral CPU 41 notifies the fare that is paid by each of the users to the first information processing device 201 and the second information processing device 202 (step S766). Specifically, the referral CPU 41 notifies information necessary for the payment using the payment system that is registered by the user to the first information processing device 201 and the second information processing device 202, on the basis of the payment information recorded in the payment information field of the user DB 51. The referral CPU 41 returns to step S701.

The first CPU 211 performs processing of remitting the fare that the user I covers to the taxi company (step S565). Specifically, the first CPU 211 activates the application of the payment service, on the basis of time information received from the referral CPU 41, and displays the account of the remittance destination and the amount of remittance. The user, for example, performs a manipulation such as inputting an approval code, and thus, the payment is executed.

The first CPU 211 ends the processing. The second CPU 212 performs processing of remitting the fare that the user K covers to the taxi company (step S665). The second CPU 212 ends the processing.

In step S766, the referral CPU 41 may transmit the information necessary for the payment to the information processing device 20 through the payment service. A route in which the information necessary for the payment is transmitted to the information processing device 20 may be different for each payment service.

Note that, the user may use a credit card instead of the small amount payment service. Regarding a user hoping to use a credit card, information relevant to credit card payment is recorded in the payment information field of the user DB 51.

In a case where the user hopes to use the credit card payment, in step S766, the referral CPU 41 notifies the information necessary for the payment to the credit-card company that is registered by the user, on the basis of the payment information recorded in the payment information field of the user DB 51. The referral CPU 41 notifies the fact that the processing of the credit card payment is performed and the amount to the information processing device 20 that is used by the user hoping to use the credit card payment. The referral CPU 41 returns to step S701.

The taxi fare is paid to the taxi company from the credit-card company, on the basis of a contract between the credit-card company and the taxi company. A credit amount is charged to the user from the credit-card company on a predetermined due date, and the payment is performed with respect to the credit-card company from the user.

In the payment information field, a plurality of payment means may be recorded, and the payment means to be used may be capable of being selected each time when the user uses the taxi sharing system 10.

The user I may pay the fare that the user covers to the driver by arbitrary means such as cash or a credit card at the time of getting out of the taxi. In such a case, in step S564, the first CPU 211 transmits the friend fare and the amount paid by the user I to the referral server 40 (step S564). Step S565 may is not executed.

The fare may be paid to the taxi company from the user, on the basis of the amount calculated at the time of performing the matching. In such a case, step S564, step S664, and step S763 to step S766 are not executed. In step S565 and step S665, each of the CPUs 21 performs processing of remitting the fare that is received from the referral CPU 41 at the time of performing the matching to the taxi company.

According to this embodiment, it is possible to attain the taxi sharing system 10 in which the ride leader and the ride friend are capable of paying the fare to the taxi company directly or through the payment agency, without performing money transfer between the ride leader and the ride friend.

### Seventh Embodiment

This embodiment relates to the taxi sharing system 10 that keeps the taxi fare of each of the users and collectively pays the fare to the taxi company. The description of the same parts as those of the sixth embodiment will be omitted.

FIG. 30 is an explanatory diagram describing the outline of the fare of the taxi sharing system 10 of a seventh embodiment. The user I pays 1606 yen that is the total amount of 1285 yen that is the first taxi fare corresponding to 50% of the fare of 2570 yen in a case where the user I independently gets in the taxi and the first charge of 321 yen to the operator of the referral server 40.

The user K pays 2556 yen that is the total amount of 2245 yen obtained by subtracting the first taxi fare that is paid by the user I from the second taxi fare from the A station to the C station and the second charge of 321 yen to the operator of the referral server 40. The referral CPU 41 remits the second taxi fare of 3530 yen from the A station to the C station to the taxi company.

FIG. 31 is a flowchart describing a processing flow of the program of the seventh embodiment. The first half of the program is the same as the first half of the program of the sixth embodiment illustrated in FIG. 28, and thus, the flowchart and the description thereof will be omitted.

Both of the users who agree with sharing the taxi select the approval button 720 of the screen described by using FIG. 12 at the time of finding a taxi to take and starting to the sharing.

The first CPU 211 accepts the selection of the approval button 720 (step S571). The first CPU 211 acquires the taxi ID that is uniquely applied to the taxi that the user gets in (step S572). The first CPU 211 transmits the taxi ID to the referral server 40 (step S573).

The second CPU 212 accepts the selection of the approval button 720 (step S671). The second CPU 212 acquires the taxi ID that is uniquely applied to the taxi that the user gets in (step S672). The second CPU 212 transmits the taxi ID to the referral server 40 (step S673).

The referral CPU 41 temporarily records each of the user ID and the taxi ID in the auxiliary storage device 43 in association with each other (step S772).

The taxi arrives at the getting-out spot of the user I with the first information processing device 201. The first CPU 211 transmits the friend fare from the departure spot to the getting-out spot of the user I who is a ride friend, to the referral server 40 (step S574).

The referral CPU 41 temporarily records the user ID of the user I, the taxi ID, and the friend fare in the auxiliary storage device 43 in association with each other (step S773).

The taxi arrives at the getting-out spot of the user K with the second information processing device 202. The second CPU 212 transmits the second taxi fare from the departure spot to the getting-out spot of the user K who is a ride leader, to the referral server 40 (step S674).

The referral CPU 41 temporarily records the user ID of the user K, the taxi ID, and the second taxi fare in the auxiliary storage device 43 in association with each other (step S774). The referral CPU 41 calculates the taxi fare to be allocated into each of the user I and the user K (step S775). The referral CPU 41 notifies the fare paid by each of the users to the first information processing device 201 and the second information processing device 202 (step S776).

The first CPU 211 performs processing of remitting the fare that the user I covers and the first charge to the operator of the taxi sharing system 10 (step S575). The first CPU 211 ends the processing. The second CPU 212 performs processing of remitting the fare that the user K covers and the second charge to the operator of the taxi sharing system 10 (step S675). The second CPU 212 ends the processing.

The referral CPU 41 checks that the payment is performed through the payment service that is registered by each of the users (step S777). The referral CPU 41 performs processing of remitting the second taxi fare to the taxi company (step S778). The referral CPU 41 returns to step S701.

Note that, for example, the payment may be performed at the end of the month by an agreement between the operator of the taxi sharing system 10 and the taxi company, without performing the processing of step S778.

The user may use a credit card instead of the small amount payment service. Regarding a user hoping to use a credit card, the information relevant to the credit card payment is recorded in the payment information field of the user DB 51.

In a case where the user hopes to use the credit card payment, in step S776, the referral CPU 41 notifies the information necessary for the payment to the credit-card company that is registered by the user. The referral CPU 41 notifies the fact that the processing of the credit card payment is performed and the amount to the information processing device 20 that is used by the user hoping to use the credit card payment.

In step S777, the referral CPU 41 checks that a use approval is obtained from the credit-card company, and proceeds to step S778.

According to this embodiment, it is possible to attain the taxi sharing system 10 in which the ride leader and the ride friend are capable of paying the fare to the taxi company directly or through the payment agency, without performing the money transfer between the ride leader and the ride friend.

### Eighth Embodiment

This embodiment relates to the taxi sharing system 10 in which a condition relevant to a fare such as covering a large part of the fare can be presented by the user. The description of the same parts as those of the first embodiment will be omitted.

FIG. 32 is an explanatory diagram describing a record layout of a condition DB. The condition DB is a DB in which the name and the contents of a condition that is allowable by the user are recorded by being associated with each other. The condition DB includes a condition name field, a cost field, a time field, and other fields.

In the condition name field, a condition name that is presented to the user is recorded. In the cost field, a condition relevant to the cost that is paid by the user is recorded. In the time field, a condition relevant to a required time is recorded. In other fields, other conditions are recorded. “-” indicates a blank. The condition DB includes one record with respect to one condition.

A specific example will be described. “No Setting” in the first column indicates a case where a particular condition is not set as with the first embodiment. In a case where the cost that the user pays by combining the charge and the taxi fare is less than a general taxi fare, the matching is performed.

“Entire Amount Payment Available” in the second column indicates a condition in which the sharing is performed by covering the entire amount of the cost of the sharing partner cover. In a case where the cost that is paid by the user is less than or equal to three times the general taxi fare and the required time is equivalent to the general required time, the matching is performed. For example, in a case where there is a huge line on a taxi stand, the user is capable of quickly getting in a taxi insofar as the user is capable of being matched with a sharing partner in the front of the line. For this reason, the condition described above is a condition that is selected by a user who is willing to pay a cost approximately three times the general taxi fare.

“1000 Yen Plus” in the third column indicates a condition in which the user covers 1000 yen of the taxi fare, and the sharing partner covers the residue as with the embodiments. In a case where the cost that is paid by the user is less than the general taxi fare and the required time is approximately 1.1 times the general required time, the matching is performed.

“Entire Amount Payment Available for Woman Only” in the last column indicates a condition in which in a case where the sharing partner is female, the sharing is performed by covering the entire amount of the cost of the sharing partner. In a case where the cost that is paid by the user is less than or equal to three times the general taxi fare and the required time is equivalent to the general required time, and the partner is female, the matching is performed.

The conditions illustrated in FIG. 32 are all examples. Each of the users may be capable of preparing a condition of the own preference.

FIG. 33 and FIG. 34 are explanatory diagrams illustrating a screen that is displayed by the information processing device 20 of an eighth embodiment. The screen illustrated in FIG. 33 illustrates an input screen that is displayed on the display unit 262 of the second information processing device 202, instead of the screen described by using FIG. 7. A desired getting-in time section 612, a headcount section 613, and a condition section 614 are added between the getting-in spot name section 611 and the matching request button 711.

The desired getting-in time section 612 accepts the input of a desired getting-in time by the user. The headcount section 613 accepts the input of the number of passengers by the user. The condition section 614 accepts the selection by the user from the conditions recorded in the condition DB. Note that, the user may be capable of suitably inputting a detailed condition or an arbitrary condition that is not recorded in the condition DB. The user hoping to share a taxi selects the matching request button 711 after the input of each of the items is completed.

The screen illustrated in FIG. 34 illustrates a referral screen that is displayed on the display unit 261 of the first information processing device 201, instead of the screen described by using FIG. 9. In the cost section 654, it is displayed that the cost that the user covers is 0 yen in the case of sharing with the user K. In the check window 66, it is also displayed that the user K covers 100% of the cost.

FIG. 35 is a flowchart describing a processing flow of a matching subroutine of the eighth embodiment. The subroutine illustrated in FIG. 35 is a subroutine that is used instead of the subroutine described by using FIG. 14. The processing up to step S754 is the same as the subroutine described by using FIG. 14, and thus, the description thereof will be omitted.

The referral CPU 41 calculates the cost that each of the ride friend and the ride leader covers, by using a condition relevant to the fare set by each of the users (step S781). The referral CPU 41 determines whether or not the cost that the ride leader covers, the required time, and the like satisfy the condition set by the ride leader (step S782).

In a case where it is determined that the condition is satisfied (in step S782, YES), the referral CPU 41 determines whether or not the cost that the ride friend covers, the required time, and the like satisfy the condition set by the ride friend (step S783). In a case where it is determined that the condition is satisfied, the referral CPU 41 ends the processing.

In a case where it is determined that the condition of the ride leader is not satisfied (in step S782, NO) or in a case where it is determined that the condition of the ride friend is not satisfied (in step S783, NO), the referral CPU 41 determines whether or not the user corresponding to the second record is the ride leader (step S758). The subsequent processing is the same as that of the subroutine described by using FIG. 14, and thus, the description thereof will be omitted.

According to this embodiment, it is possible to provide the taxi sharing system 10 in which the matching is performed in a condition relevant to a desired fare of the user.

The taxi sharing system 10 of this embodiment can be used even in a situation in which users sharing a taxi are matched before getting in the taxi and in a situation in which a user being moved in a taxi and the other user are matched. That is, the user presenting the condition relevant to the fare by using the screen described by using FIG. 33 may be a user in a taxi, or may be a user before getting in a taxi.

A condition relevant to a desired fare of the user who is already in the taxi, for example, may be “Please, Pay Entire Amount” (the user who is in the taxi does not cover the fare, but the user who is not yet in the taxi covers the entire amount of the fare), “Please Pay 1000 Yen More” (the user who is not yet in the taxi covers 1000 yen more), or the like.

Note that, as described above, a condition that is determinately set by the user presenting the condition may be presented, or a fluctuating condition that is set by the user presenting the condition may be presented, as the condition relevant to the fare. For example, in a case where one user presents “Pay Fare at Highest Rate” as the condition relevant to the fare (the fluctuating condition), in such a condition, the other user receiving the presentation presents the amount that the other user is capable of covering, for example, “Pay Entire Amount”, “1000 Yen Plus”, and the like (the condition that is determinately set), and the one user selects a user presenting an allowable condition from the conditions presented by the other user, as the user who shares the taxi, and thus, the matching may be established.

### Ninth Embodiment

FIG. 36 is a functional block diagram of the taxi sharing system 10 of a ninth embodiment. The taxi sharing system 10 includes the referral server 40, and the plurality of information processing devices 20, which are connected through a network. The information processing device 20 includes a condition acquisition unit 81 and a condition transmitting unit 82. The condition acquisition unit 81 acquires the getting-in spot and the getting-out spot from each of the users. The condition transmitting unit 82 transmits the getting-in spot and the getting-out spot, which are acquired by the condition acquisition unit 81.

The referral server 40 includes a condition receiving unit 86 and a matching transmitting unit 87. The condition receiving unit 86 receives the getting-in spot and the getting-out spot of each of the users, which are transmitted from the condition acquisition unit 81. The matching transmitting unit 87 transmits information relevant to the other user and the predicted cost in the case of sharing a taxi to the information processing device 20 associated with each of a first user and a second user who are extracted from the users.

The information processing device 20 includes a matching output unit 83, a selection accepting unit 84, and a selection transmitting unit 85.

The matching output unit 83 outputs the information relevant to the other user and the predicted cost, which are transmitted from the matching transmitting unit 87. The selection accepting unit 84 accepts the selection of whether or not to share the taxi from the user. The selection transmitting unit 85 transmits the selection that is accepted by the selection accepting unit 84 to the referral server 40.

The referral server 40 includes a cost collection unit 88 and a cost payment unit 89. In a case where the selection to the effect of sharing the taxi is received from the selection transmitting unit 85 of the information processing device 20 associated with each of the first user and the second user, the cost collection unit 88 collects a cost according to the first user from the first user who gets out of the taxi in the middle. The cost payment unit 89 pays a cost obtained by subtracting a charge from the cost collected by the cost collection unit 88 to the second user.

### Tenth Embodiment

This embodiment relates to an aspect of attaining the referral server 40 for the taxi sharing system 10 of this embodiment by operating a general server computer and a program 97 in combination. FIG. 37 is an explanatory diagram illustrating the configuration of the taxi sharing system 10 of a tenth embodiment. Note that, the description of the same parts as those of the first embodiment will be omitted.

The taxi sharing system 10 of this embodiment includes the plurality of information processing devices 20 and a server computer 90, which are connected through a network. The server computer 90 includes the referral CPU 41, the main storage device 42, the auxiliary storage device 43, the communication unit 44, a reading unit 45, and the bus.

The program 97 is recorded in a portable recording medium 96.

The referral CPU 41 reads the program 97 through the reading unit 45, and stores the program 97 in the auxiliary storage device 43. In addition, the referral CPU 41 may read out the program 97 that is stored in a semiconductor memory 98 such as a flash memory mounted on the server computer 90. Further, the referral CPU 41 may download the program 97 from the other server computer (not illustrated) that is connected through the communication unit 44 and a network (not illustrated), and may store the program 97 in the auxiliary storage device 43.

The program 97 is installed as a control program of the server computer 90, and is executed by being loaded in the main storage device 42. Accordingly, the server computer 90 functions as the referral server 40 described above.

In each of the information processing devices 20, the program of this embodiment is transmitted to the auxiliary storage device 23 from an application providing server (not illustrated) through a network. The program is installed as a control program of the information processing device 20, and is executed by being loaded in the main storage device 22. As described above, the program functions as the taxi sharing system 10 described above in conjunction with the server computer 90 and the information processing device 20.

The technical features (constituents) described in each example can be combined with each other, and new technical features can be formed by the combination.

It should be considered that the embodiments disclosed here are examples in all respects and are not restrictive. The scope of the present invention is represented not by the meaning described above but by the scope of the claims, and is intended to include meanings equivalent to the scope of the claims and all modifications within the scope.

It is to be noted that, as used herein and in the appended claims, the singular forms “a”, “an”, and “the” include plural referents unless the context clearly dictates otherwise.

1-15. (canceled)

16. A non-transitory computer readable medium including program instructions which when executed by a processor causing a computer to execute a process comprising:
acquiring, by the processor, a candidate sharing a taxi and a calculated cost in the case of sharing with the candidate;
displaying, by the processor, the candidate and the calculated cost that are acquired; and
accepting, by the processor, selection of whether or not to share with the displayed candidate.

17. The non-transitory computer readable medium according to claim 16,
wherein whether or not the candidate is a stopping-off passenger who gets out of the taxi in the middle is displayed.

18. The non-transitory computer readable medium according to claim 16,
wherein in a case where the candidate is the stopping-off passenger who gets out of the taxi in the middle,
the calculated cost includes a first taxi fare that the stopping-off passenger pays a sharing partner, and a charge, and
the first taxi fare and the charge are displayed.

19. The non-transitory computer readable medium according to claim 16,
wherein in a case where the candidate is a final getting-out passenger who gets out of the taxi at a final getting-out spot,
the calculated cost includes a balance amount between a second taxi fare from a getting-in spot to the final getting-out spot and the first taxi fare that is accepted from the sharing partner, and the charge, and
the first taxi fare, the second taxi fare, and the charge are displayed.

20. The non-transitory computer readable medium according to claim 16,
wherein input of a message of a candidate destination is accepted and transmitted, and
a message from the candidate is acquired and displayed.

21. The non-transitory computer readable medium according to claim 16,
wherein a position of the candidate is acquired, and
the acquired position is displayed on a map.

22. The non-transitory computer readable medium according to claim 16,
wherein a condition for filtering the candidate is accepted,
the accepted condition is transmitted, and
the filtered candidate is acquired on the basis of the condition.

23. The non-transitory computer readable medium according to claim 16,
wherein input of attribute of a taxi that is hoped to get in is accepted, and
dispatch of a taxi matching to the accepted attribute is requested.

24. A non-transitory computer readable medium including program instructions which when executed by a processor causing a computer to execute a process comprising:
acquiring a getting-in spot and a getting-out spot of each user;
outputting, by the processor, information relevant to the other user and a calculated cost in the case of sharing a taxi to each of a first user and a second user extracted from the users;
accepting, by the processor, selection of whether or not to share the taxi from the first user and the second user;
collecting, by the processor, a cost for the first user from the first user who gets out of the taxi in the middle in the case of accepting selection of sharing a taxi from the first user and a second user; and
paying, by the processor, a cost obtained by subtracting a charge from the cost collected from the first user to the second user.

25. The non-transitory computer readable medium according to claim 24,
wherein whether or not the second user satisfies a second condition in which a condition for rejecting sharing a taxi is determined with respect to the first user,
whether or not the first user satisfies a first condition in which a condition for rejecting sharing a taxi is determined with respect to the second user, and
in a case where the first user does not satisfy the second condition and the second user does not satisfy the first condition,
the information relevant to the other user and the calculated cost in the case of sharing a taxi are output to each of the first user and the second user.

26. The non-transitory computer readable medium according to claim 24,
wherein a first cost including a first taxi fare that is paid to the second user and a first charge is notified to the first user, and
a second cost including a balance amount between a second taxi fare predicting a cost from the getting-in spot to a final getting-out spot and the first taxi fare, and a second charge is notified to the second user.

27. The non-transitory computer readable medium according to claim 26,
wherein when the first cost is less than a calculated cost that is paid in a case where the first user independently gets in a taxi, and the second cost is less than a calculated cost that is paid in a case where the second user independently gets in a taxi,
information relevant to the second user and the first cost are output to the first user, and
information relevant to the first user and the second cost are output to the second user.

28. A non-transitory computer readable medium including program instructions which when executed by a processor causing a computer to execute a process comprising:
acquiring, by the processor, a candidate sharing a vehicle and a calculated cost in the case of sharing with the candidate;
displaying, by the processor, the candidate and the calculated cost that are acquired; and
accepting, by the processor, selection of whether or not to share with the displayed candidate.

29. An information processing method for causing an information processing apparatus to perform processing of:
acquiring, by a processor, a candidate sharing a taxi and a calculated cost in the case of sharing with the candidate;
displaying, by the processor, the candidate and the calculated cost that are acquired; and
accepting, by the processor, selection of whether or not to share with the displayed candidate.

30. An information processing method for causing an information processing apparatus to perform processing of:
acquiring, by a processor, getting-in spot and a getting-out spot of each user;
outputting information relevant to the other user and a calculated cost in the case of sharing a taxi to each of a first user and a second user extracted from the users;
accepting, by the processor, selection of whether or not to share a taxi from the first user and the second user;
collecting, by the processor, a cost for the first user from the first user who gets out of the taxi in the middle in the case of accepting selection of sharing a taxi from the first user and the second user; and
paying, by the processor, a cost obtained by subtracting a charge from the cost collected from the first user to the second user.
